(19) United States
(12) Patent Application Publication
(10) Pub. No.: US 2020/0054170 A1
(43) Pub. Date: Feb. 20, 2020

(54) PAN WITH A MOVABLE SPLATTER PREVENTION DEVICE

(71) Applicants: Rubens Pertence DE CAMPOS, BELO HORIZONTE (BR); Paulo Vitor PERTENCE DE SOUZA, BELO HORIZONTE (BR)

(72) Inventors: Rubens Pertence DE CAMPOS, BELO HORIZONTE (BR); Paulo Vitor PERTENCE DE SOUZA, BELO HORIZONTE (BR)

(21) Appl. No.: 16/347,154

(22) PCT Filed: Nov. 7, 2017
(86) PCT No.: PCT/BR2017/050335

§ 371 Date: May 2, 2019

(30) Foreign Application Priority Data
Nov. 8, 2016 (BR) BR1020160261457

(51) Int. Cl. A47J 37/10

(52) U.S. Cl. CPC A47J 37/108; A47J 37/101

(57) ABSTRACT

The present pan is adapted to prevent sideways splatters of fat, namely horizontal splatters, and splatters of fat traveling from the bottom upwards, namely vertical splatters, and is also adapted to allow the pan to be covered with a lid, which is held suspended three centimeters above the edge of the pan to allow air to enter the pan, without smothering the frying food or causing water to form at the bottom of the pan.

### CROSS-REFERENCE TO RELATED APPLICATION

This application is a National Stage Entry of International Application No. PCT/BR2017/050335, filed Nov. 7, 2017, which claims priority to Brazilian Application No. 1020160261457, filed Nov. 8, 2016. The entire disclosures of the aforementioned applications are incorporated herein by reference.

### BACKGROUND

The present invention refers to a pan having a different format to conventional ones already on the market and which has a movable splatter prevention device on the central upper edge designed to neutralize the vertical fat splatters which are those from the bottom of the pan that splash from bottom to top and the horizontal splashes which are those that splash through the sides of the pan and being able to make use of the lid that frying does not that smother and does not even form water at the bottom of the pan.

Splashes come from fried foods made in household or industrial cookers when frying any type of foods in common pans which are the already existing conventional ones, that cannot prevent splashes of fat droplets that spread to all sides and dirty the entire cooker and even beyond the kitchen.

The pans currently on the market for cooker frying are totally inefficient in the matter of preventing splashes and do not solve the problem of fat droplet splashes on the cooker and are frying pans without a lid; frying pans with lid; saucepans with lid; frying pans with a perforated lid; frying guards and perforated lids for frying.

In the first case which is the common frying pan without a lid, there is the drawback of placing the food to be fried directly into the frying pan with heated oil that immediately splatters to the sides and from bottom to top.

The second case which is the frying pan with a lid would be the same process as the frying pan with the lid and when using the lid, it smothers the frying and forms water instead of frying, cooking the food when the aim is to fry.

The third case of the saucepan with lid would be the same process as the frying pan with a lid and when using the lid to prevent splashing, the food being fried accumulates water and does not fry but cooks instead.

In the fourth case of the frying pan with a perforated lid, when placing the food to fry in hot oil, butter or lard, fat droplets automatically splatter the cooker and by the time the perforated lid has been placed, it has already soiled the whole cooker and the perforated lid which is designed not to smother the frying so as not to create condensation, is not effective enough, and despite the perforations on the lid, the frying accumulates water at the bottom of the pan.

In the fifth case which is the round-shaped frying guards with perforations throughout and with a handle for handling, to be placed on the edge of frying pans or saucepans, do not solve the problems of vertical and horizontal fat droplet splashing.

Frying pans and saucepans that are pans to make fried foods are known in the market and have been sold for decades, working on the principle, placing steaks, pork rind, sausages, potatoes directly into the frying pan or saucepan with already heated oil and fat automatically splashes everywhere and which are the horizontal splash that are called side splashes and which splash over the edge of the pan and the vertical splashes which are the splashes that splatter from the bottom of the pan out upwardly from the bottom of the pan outwardly and when using the lid to prevent splashing, water accumulates in the fry and instead of frying, it boils the fry and since the cooker is most affected and the target of fat spatter when frying and having its tabletop, glass top, trivets and burners completely covered with fat splashes from frying foods in conventional pans and not even the air purifier and that fat that stays on the cooker is the solution to prevent fat spatter when frying.

### SUMMARY

In order to remedy such drawbacks, this pan has been developed with a movable splatter prevention device, the device being shaped like a ring and with a central hollow and having four guide pins in the vertical position embedded in the device and which will be used at the edge of the pan, so that this device keeps the lid of the pan suspended three centimeters relative to the upper edge of the pan for air intake so as not to smother the frying or form water at the bottom of the pan, the aim being to fry without soiling the cooker and eliminating about 99% of the dirt with splashes of fat droplets from the process of making fried foods on a household or industrial cooker and this pan with movable splatter prevention device can be made of aluminum, non-stick aluminum, stainless steel, cast iron, non-stick ceramic or induction ceramic, and may be in the shape of a frying pan with a handle or with two side grips with a lid or in the shape of a saucepan with two handles on the sides and a lid, the difference being that the edge of the pan does not come into contact with the edge of the lid in the frying process, the upper edge diameter maintaining the measurements of standard market pans which are twenty-four centimeters, twenty-six centimeters, twenty-eight centimeters and thirty centimeters.

### BRIEF DESCRIPTION OF THE DRAWINGS

The pan with the movable splatter prevention device can be better understood through the following detailed description in line with the accompanying figures, where:

FIG. 1 represents a front view of the pan for frying with the movable splatter prevention device

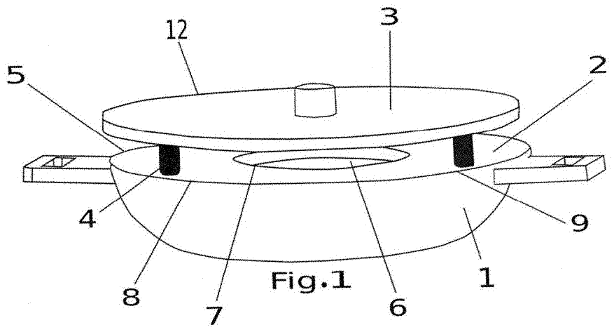

FIG. 2 represents a cutaway view of the pan for frying with the movable splatter prevention device

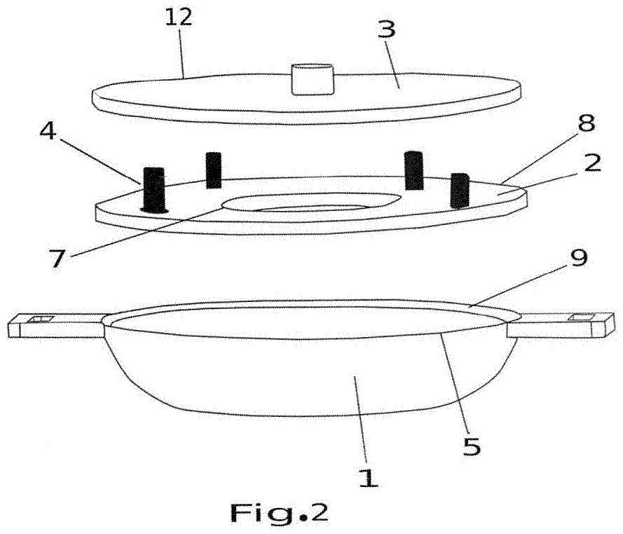

FIG. 3 represents a front view of the pan with the movable splatter prevention device and without the lid

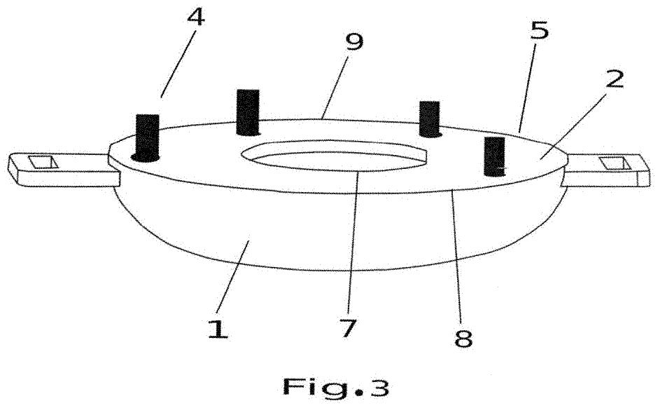

FIG. 4 represents a front view of the pan with the lid on the four guide pins of the movable splatter prevention device to keep the lid three centimeters suspended over the edge of the pan for air intake and not to smother the frying or water formation at the bottom of the pan.

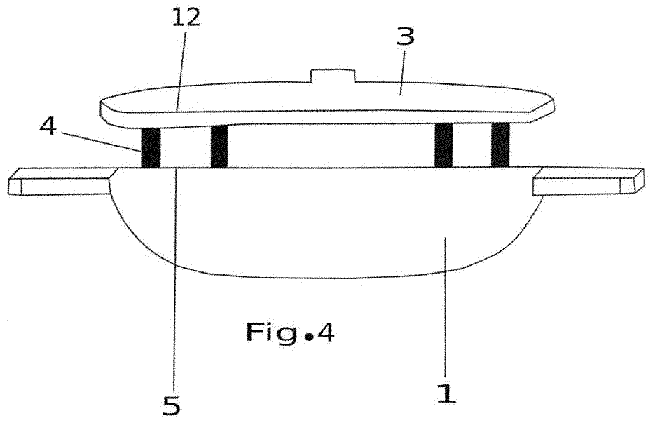

FIG. 5 represents a vertical view from top to bottom of the pan with the lid

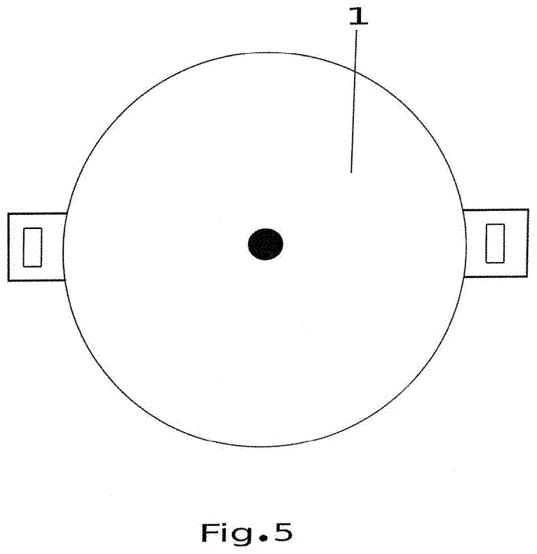

FIG. 6 represents a vertical view from top to bottom of the pan with the movable splatter prevention device and without the lid

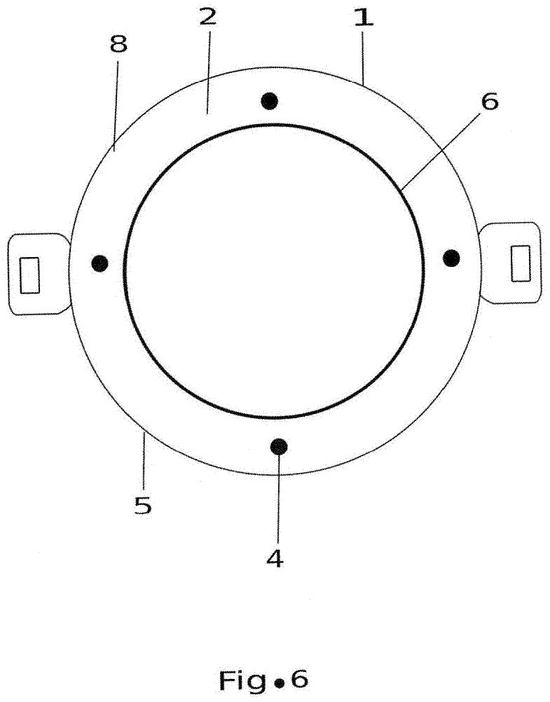

FIG. 7 represents a vertical view from top to bottom of the pan without the movable splatter prevention device and without the lid

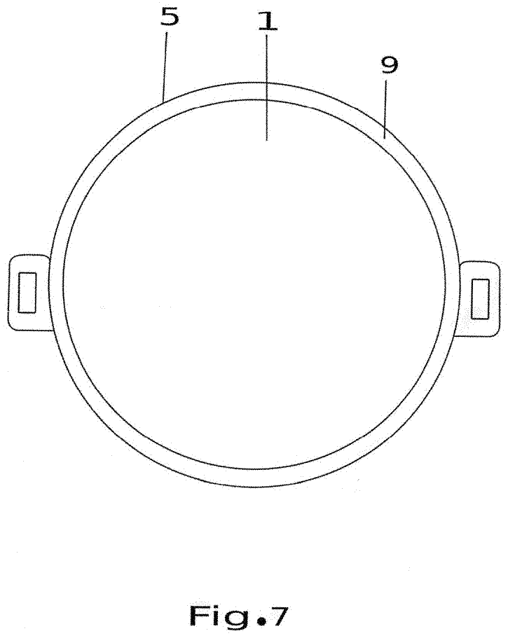

FIG. 8 represents a front view of a pan without any splatter prevention device and shows the positions of the horizontal splatter of fat droplets which are the sides splashes that splatter through the edges of the pan and the vertical splashes which splatter upwardly from the bottom of the pan.

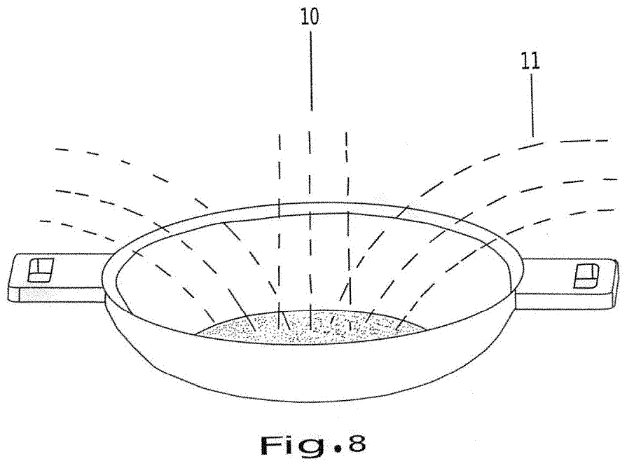

### DETAILED DESCRIPTION

With reference to these figures, it can be noted that the pan (1) which has a movable splatter prevention device (2) has the function of neutralizing splashes of fat droplets in the vertical (10) and horizontal (11) positions, has an upper edge (5) with a ledge on the inside (9) specifically for placing thereon the movable splatter prevention device (2) that has a central edge (7) having a lesser diameter than its outer edge (8) and which has the function of neutralizing the splatter of fat droplets out of the pan (1) in the horizontal position (11) which are the side splashes when beginning the frying process in the pan (1) and that after beginning the frying, the lid (3) is placed on the four guide pins (4) that are embedded or screwed vertically onto the movable splatter prevention device itself (2) which is designed to keep the lid (3) three centimeters suspended from the upper edge (5) of the pan (1) to allow air to enter (6) to prevent smothering the frying and water formation at the bottom of the pan (1) and fulfills the function of frying and not cooking the fry and the lid (3) also has a second function which is to neutralize splashes of fat droplets that try to get out in vertical position (10) from the bottom of the pan (1) and which splatter upwardly.

The present invention refers to a pan that can be in the shape of a frying pan with a handle or with two side grips and both having their own lid or in the shape of a saucepan with its own lid, but having the differentiating factor that the edge of the pan does not come into contact with the edge of the lid in the process of frying foods, because it has a neutralizing system in the middle between the edge of the pan and the edge of the lid, which has the multiple function of neutralize vertical fat splatters which are those from the bottom of the pan that splatter upwardly and the horizontal splashes which spatter the sides of the pan and can make use of the lid, without smothering the frying food or causing water to form.

1. A pan with a movable splatter prevention device, comprising:
a lid;
a pan made of one or more of the following: aluminum, aluminum with a non-stick coating, stainless steel, cast iron, non-stick ceramic, and induction ceramic, wherein the pan has an upper edge diameter maintaining of between twenty-four centimeters and thirty centimeters, wherein the pan includes one or more of the following: a handle and two side grips, the upper edge of the pan being spaced away from an edge of the lid;
a movable splatter prevention device made of one or more of the following: aluminum, nonstick aluminum, stainless steel, cast iron, and heat-resistant thermoplastic, the movable splatter prevention device having a receiving surface configured to sit on a ledge formed on an upper inside surface of the upper edge of the pan to receive the movable splatter prevention device, the movable splatter prevention device having a central edge having a lesser diameter than an outer edge of the movable splatter prevention device, the central edge forming an aperture through the movable splatter prevention device;
wherein the movable splatter prevention device includes four guide pins made of one or more of the following: metal and rubberized metal, each of the four guide pins being three centimeters long and vertically embedded or screwed into the movable splatter prevention device, the four guide pins being configured to receive an inner surface of the lid to suspend the lid over three centimeters above the upper edge of the pan when seated on the four guide pins to allow air to enter the pan thereby preventing smothering during cooking and preventing water to form at a bottom of the pan.
